(19) United States
(12) Patent Application Publication
(10) Pub. No.: US 2025/0084228 A1
(43) Pub. Date: Mar. 13, 2025

(54) EXPANDABLE, SHELF STABLE POLYMER BEAD

(71) Applicant: SABIC GLOBAL TECHNOLOGIES B.V., Bergen op Zoom (NL)

(72) Inventors: James Arthur AUGER, Geleen (NL); Syed Mahmood AHMED, Geleen (NL); Abdul Rahim Ahamed ARAFATH, Geleen (NL); Ali Khalid AL-KHORAYEF, Geleen (NL)

(21) Appl. No.: 18/959,891

(22) Filed: Nov. 26, 2024

Related U.S. Application Data
(62) Division of application No. 17/299,346, filed on Jun. 3, 2021.

(30) Foreign Application Priority Data
Dec. 5, 2018 (EP) 18210363.0

(51) Int. Cl. C08J 9/16; C08J 9/00

(52) U.S. Cl. CPC C08J 9/16; C08J 9/0061; C08J 2203/22; C08J 2423/08; C08J 2423/14

(57) ABSTRACT

The invention relates to an expandable bead comprising
a) a polyolefin selected from polyethylene (PE), polypropylene (PP) and mixtures thereof and
b) thermoplastic microspheres encapsulating a blowing agent.

### CROSS-REFERENCE TO RELATED APPLICATIONS

This application is division of U.S. application Ser. No. 17/299,346, filed Jun. 3, 2021, which is a National Stage application of PCT/EP2019/081999, filed Nov. 20, 2019, which claims benefit of European Application No. 18210363.0 filed on Dec. 5, 2018, all of which are incorporated by reference herein in their entirety.

The present invention relates to expandable polymer beads and their preparation.

Foams based on polymer beads offer the advantage to manufacture large three-dimensional structures with very low densities and complex geometries. They are widely used in a range of applications. Typical examples are packaging material and parts for automotive applications such as bumper cores, battery covers, armrest, steering column pads and floor spacers. Such bead foams are made of polymeric beads containing a blowing agent or a combination of blowing agents.

A special class of beads are polyolefin based beads. They yield in foamed structures with a high dimensional stability, chemical resistance and good mechanical properties. They can for example be manufactured by extrusion and autoclave processes. Both processes involve impregnation of the beads with gas under high pressure and yield in expanded polyolefin beads. Thereby the gas serves as blowing agent to expand the beads.

The extrusion process encompasses of melting the polyolefin resin pellets in the extruder, injection of blowing agent into the polyolefin melt and cutting the expanded polyolefin strand emerging from the extruder into expanded beads.

The autoclave process encompasses two steps. First, the polyolefin resin pellets are converted into polyolefin beads of desired diameter by extrusion and underwater pelletizing process. The second step of the process involves the dispersion of the polyolefin beads in water in the autoclave using a suspending aid followed by heating the autoclave contents to the temperatures above the softening point of the resin and then injecting the blowing agent into the autoclave to impregnate the beads with the blowing agent. The hot impregnated polyolefin beads at high pressure are then discharged into a large flashing vessel maintained at atmospheric pressure. The resulting expanded polyolefin beads are separated from water, dried and packed out for shipping.

Main disadvantage of currently manufactured polyolefin beads is that these are produced only in the expanded form. Due to the diffusion of the gas, which serves as blowing agent, out of the beads, the beads cannot be produced and stored in unexpanded form and need to be transported as expanded beads to converters for shape molding the beads. This makes transport and storage complicated and expensive. Another disadvantage is that the molder cannot manufacture and expand the beads to any desired density depending upon his requirement. This also limits the options for the molder to use the beads at densities other than supplied.

Therefore, an objective of the present invention is to provide shelf-stable, expandable polyolefin beads. This means that the beads can be stored and/or transported in unexpanded form without or without significant loss of blowing agent. This saves transport costs and gives the option for the molder to use the product over a wide range of desired densities depending on its application. Another objective is to provide a process for the production of the beads.

The expandable bead according to the invention comprises
a) a polyolefin selected from polyethylene (PE), polypropylene (PP) and mixtures thereof and
b) thermoplastic microspheres encapsulating a blowing agent.

Thereby the polyolefin may constitute the matrix, wherein the thermoplastic microsphere may be dispersed within the matrix.

By application of the invention, the aforementioned object is met, at least in part. It is an advantage of the present invention that the expandable bead according to the invention can be stored and/or transported in unexpanded form without or without significant loss of blowing agent. Furthermore, the expandable bead the according to the invention can be foamed over a wide range of desired densities depending on the application of the product. The desired densities can be controlled by the conditions of the foaming process. This gives converters the freedom to tailor properties of the end-product.

Preferably, the expandable bead comprises the polyolefin in the range from ≥70% by weight to ≤98% by weight, preferably from >75% by weight to ≤98% by weight, more preferably from ≥80% by weight to ≤98% by weight, more preferably from ≥85% by weight to ≤98% by weight, wherein the total amount of the polyolefin and the thermoplastic microspheres is 100% by weight.

Further it is preferred that the expandable bead comprises
a) a polyolefin selected from polyethylene (PE), polypropylene (PP) and mixtures thereof and
b) thermoplastic microspheres encapsulating a blowing agent,
and that the expandable bead comprises the polyolefin in the range from ≥70% by weight to ≤98% by weight, more preferably from ≥85% by weight to ≤98% by weight, wherein the total amount of the polyolefin and the thermoplastic microspheres is 100% by weight.

Beads comprising binary mixtures of polyolefins, may have advantages in the production of articles by fusion, such as in a steam chest molding process. Such mixtures have usually two melting points, which ensures that the beads can be easily fused together while maintaining mechanical stability when molded at temperatures between the two melting points.

### Polypropylene (PP)

Preferably, the expandable bead comprises mixtures of polypropylene and polyethylene, wherein the amount by weight of polypropylene is higher than the amount of the polyethylene.

Preferably, the amount of polypropylene in the expandable bead is more than 60% by weight, preferably more than 70% by weight, more preferably more than 80% by weight, based on the total amount of the polypropylene and the polyethylene in the bead.

More preferably, the expandable bead comprises a polyolefin, wherein the polyolefin is selected from polypropylene.

Preferably, the expandable bead comprises polypropylene in the range from ≥50% by weight to ≤98% by weight, preferably from >75% by weight to ≤98% by weight, more preferably from ≥80% by weight to ≤98% by weight, more preferably from ≥85% by weight to ≤98% by weight, wherein the total amount of polyolefin and the thermoplastic microspheres is 100% by weight.

Preferably the melt flow index (MFI) of the polypropylene ranges from >0.3 and <100 g/10 min, preferably ranges from ≥2 to ≤60 g/10 min, preferably ranges from ≥5.0 to ≤50 g/10 min, more preferably from ≥8 to ≤50 g/10 min as measured according to ISO 1133 at 230° C. and a load of 2.16 kg.

It is preferred that the expandable bead comprises
a) a polyolefin selected from polyethylene (PE), polypropylene (PP) and mixtures thereof and
b) thermoplastic microspheres encapsulating a blowing agent
and that the expandable bead comprises polypropylene in the range from ≥50% by weight to ≤98% by weight, preferably from ≥80% by weight to ≤98% by weight, wherein the total amount of polyolefin and the thermoplastic microspheres is 100% by weight and that the melt flow index (MFI) of the polypropylene ranges from >0.3 and <100 g/10 min, as measured according to ISO 1133 at 230° C. and a load of 2.16 kg.

It is further preferred that the expandable bead comprises
a) a polyolefin selected from polyethylene (PE), polypropylene (PP) and mixtures thereof and
b) thermoplastic microspheres encapsulating a blowing agent
and that the expandable bead comprises polypropylene in the range from ≥50% by weight to ≤98% by weight, preferably from ≥80% by weight to ≤98% by weight, wherein the total amount of polyolefin and the thermoplastic microspheres is 100% by weight and that the melt flow index (MFI) of the polypropylene ranges from ≥8 to ≤50 g/10 min, as measured according to ISO 1133 at 230° C. and a load of 2.16 kg.

The polypropylene may be a random PP copolymer or a PP homopolymer or PP-UMS or mixtures thereof. Preferably the polypropylene is random PP copolymer.

Preferably, the expandable bead comprises
a) a polyolefin selected from polyethylene (PE), random polypropylene copolymer and mixtures thereof and
b) thermoplastic microspheres encapsulating a blowing agent
wherein the expandable bead comprises random polypropylene copolymer in the range from ≥50% by weight to ≤98% by weight, preferably from ≥80% by weight to ≤98% by weight, wherein the total amount of polyolefin and the thermoplastic microspheres is 100% by weight and
wherein the melt flow index (MFI) of the random polypropylene copolymer ranges from >0.3 and <100 g/10 min, as measured according to ISO 1133 at 230° C. and a load of 2.16 kg.

More preferably, the expandable bead comprises
a) a polyolefin selected from polyethylene (PE), random polypropylene copolymer and mixtures thereof and
b) thermoplastic microspheres encapsulating a blowing agent
wherein the expandable bead comprises random polypropylene copolymer in the range from ≥50% by weight to ≤98% by weight, preferably from ≥80% by weight to ≤98% by weight, wherein the total amount of polyolefin and the thermoplastic microspheres is 100% by weight and wherein the melt flow index (MFI) of the random polypropylene copolymer ranges from ≥8 to ≤50 g/10 min, as measured according to ISO 1133 at 230° C. and a load of 2.16 kg.

### Random PP Copolymer

Polypropylene compositions consisting of a propylene copolymer are known. A propylene copolymer is obtained by copolymerizing propylene and one or more other olefins, preferably ethylene, under suitable polymerization conditions. The preparation of propylene copolymers is, for example, described in Moore, E. P. (1996) Polypropylene Handbook. Polymerization, Characterization, Properties, Processing, Applications, Hanser Publishers: New York.

Preferably, the PP copolymer is a copolymer of propylene with an α-olefin, for example an α-olefin chosen from the group of α-olefin having 2 or 4 to 10 C-atoms, for example wherein the amount of α-olefin is less than 10 wt % based on the total propylene copolymer.

A copolymer of propylene with an α-olefin can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

### Homopolymer PP

Polypropylene compositions consisting of a propylene homopolymer are known. Propylene homopolymer may be obtained by polymerizing propylene under suitable polymerization conditions.

The preparation of propylene homopolymers is, for example, described in Moore, E. P. (1996) Polypropylene Handbook. Polymerization, Characterization, Properties, Processing, Applications, Hanser Publishers: New York.

Homopolymer polypropylene can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems.

### Low Density Polyethylene (LDPE)

The production processes of LDPE is summarised in Handbook of Polyethylene by Andrew Peacock (2000; Dekker; ISBN 0824795466) at pages 43-66.

It is herein understood that the term LDPE includes both an LDPE homopolymer and an LDPE copolymer. The LDPE copolymer is a copolymer of ethylene and a suitable comonomer well known to the skilled person, such as alkenes, cycloalkenes and dienes. Suitable comonomers include α-olefins with 3-12 C atoms, ethylenically unsaturated carboxylic acids, ethylenically unsaturated C4-15 carboxylic acid esters or their anhydrides. Examples of suitable α-olefins to be applied as a comonomer are propylene and/or butene. Examples of suitable ethylenically unsaturated carboxylic acids are maleic acid, fumaric acid, itaconic acid, acrylic acid, methacrylic acid and/or crotonic acid. Examples of ethylenically unsaturated C4-15 carboxylic acid esters or their anhydrides are methyl (meth) acrylate, ethyl (meth) acrylate, hydroxyethyl (meth) acrylate, hydroxypropyle (meth) acrylate, n-butyl methacrylate, vinyl acetate, methacrylic acid anhydride, maleic acid anhydride, 1,4-butanedioldimethacrylate, hexanediol dimethacrylate, 1,3-butylene glycol dimethacrylate, ethylene glycol dimethacrylate, dodecanediol dimethacrylate, trimethylol propane trimethacrylate, trimethacrylate ester and/or itaconic acid anhydride. Also bifunctional alkadienes for example 1,5-hexadiene, 1,7-octadiene, 1,9-decadiene and 1,13-tetradecadiene may be applied. The quantity of comonomer in the polymer is dependent on the desired application.

Preferably, the LDPE has a density of 915 to 935 kg/m³ according to ISO1183 and a melt flow rate of 0.10 g/10 min to 80 g/10 min according to ISO1133: 2011 measured at 190° C. and 2.16 kg. Such LDPE can be obtained via the high pressure radical polymerization of ethylene or ethylene and one or more comonomers in an autoclave or a tubular reactor.

Preferably, the LDPE has Mn of at least 5.0 kg/mol according to size exclusion chromatography and Mw of at least 50 kg/mol according to size exclusion chromatography. The LDPE may have an Mn of at most 25.0 kg/mol, for example at most 20.0 kg/mol, for example at most 17.5 kg/mol, according to size exclusion chromatography. The LDPE may have an Mw of at most 350 kg/mol, for example at most 330 kg/mol, for example at most 300 kg/mol, for example at most 250 kg/mol, according to size exclusion chromatography. The LDPE may have Mn of 5.0-10.0 kg/mol according to size exclusion chromatography and Mw of 50-200 or 50-150 kg/mol according to size exclusion chromatography. In other embodiments, the LDPE may have Mn of 10.0-20.0 kg/mol and Mw of 150-250 or 150-200 kg/mol according to size exclusion chromatography.

For size exclusion chromatography, the polymer samples are dissolved (0.9 mg/ml) in 1,2,4-trichlorobenzene (TCB), which is distilled prior to use, over a period of 4 h at 150° C. and stabilized with butylated hydroxytoluene (BHT) at a concentration of 1 mg/ml. The solutions are filtered at high temperature (150° C.) using a millipore filtration setup (1.2 mm) positioned in a Hereous LUT oven operating at 150° C. The separation of the polymer according to molar mass may be performed with a Polymer Laboratories PL GPC210. This SEC system is operated at high temperature (column compartment at 160° C., injector compartment at 160° C., and solvent reservoir at 35° C.), and a flow of 0.5 ml/min. Eluent is 1,2,4-trichlorobenzene. Two Polymer Laboratories SEC columns with large particle size (PLGel mixed A-LS 20 mm columns) in series are used to minimize shear degradation of high molar mass polymer chains. The light scattering detector (a WYATT DAWN EOS multi-angle laser light scattering detector) is placed in line between the SEC and the refractive index detector. The used dn/dc=0.097 ml/g.

Preferably, the LDPE is produced in a tubular reactor which is operated at a pressure of ≥200 and ≤280 MPa and an average reaction peak temperature of ≥220° C. and ≤300° C.

The LDPE may comprise one or more of co-monomers, which is fed to the reactor in one or more feed inlets of said tubular reactor; and each co-monomer is preferably fed to the tubular reactor in quantities of ≤2.0 mol % with regard to the total feed composition, and wherein the obtained ethylene copolymer has a co-monomer content of at least ≥0.2 mol % and at most ≤6 mol % with respect to the total mol % of ethylene and the one or more co-monomers.

### Linear Low Density Polyethylene (LLDPE)

The LLDPE according to the invention is a copolymer of ethylene with at least one α-olefin.

Linear low-density polyethylene (LLDPE) may for example be obtained by polymerizing ethylene with at least one α-olefin, which may be selected from 1-butene, 1-pentene, 4-methyl-1-pentene, 1-hexene, 1-heptene and/or 1-octene, preferably 1-butene.

Linear low-density polyethylene (LLDPE) may be produced for example using at least one or exactly one metallocene catalyst or at least one or exactly one Ziegler-Natta catalyst.

Preferably, the linear low-density polyethylene (LLDPE) used according to the invention may be produced for example using at least one Ziegler-Natta catalyst comprising Mg and at least one or one of Ti, Hf or Zr.

A copolymer of ethylene and at least one α-olefin may for example have a density as determined according to ISO 1183-1:2012, method A of ≥850 kg/m3 and ≤950 kg/m3, preferably ≥910 kg/m³ and ≤940 kg/m³, further preferred between 920 kg/m³ and 930 kg/m³.

The LLDPE may for example have an MFI as measured according to ISO 1131-1:2011 at 190° C. and at a load of 2.16 kg in the range from ≥0.1 g/10 min to ≤100 g/10 min, preferably from ≥0.5 g/10 min to ≤80 g/10 min, further preferred from ≥5 g/10 min to ≤70 g/10 min, even further preferred from ≥6 g/10 min to ≤60 g/10 min, further preferred from ≥8 g/10 min to ≤55 g/10 min.

LLDPE may preferably be produced using a gas phase or slurry process. The production processes of polyethylenes are summarised in “Handbook of Polyethylene” by Andrew Peacock (2000; Dekker; ISBN 0824795466) at pages 43-66.

Preferably, the expandable bead comprises polyethylene, wherein the polyethylene is selected from linear low density polyethylene (LLDPE).

Preferably, the expandable bead comprises polyethylene, wherein the polyethylene is selected from LLDPE having a MFI in the range from ≥5 to ≤70 g/10 min,
preferably from ≥6.0 to ≤60 g/10 min, more preferably from ≥8 to ≤55 g/10 min as measured according to ISO 1133 at 190° C. and 2.16 kg.

Preferably, the expandable bead comprises polyethylene, wherein the polyethylene is selected from LLDPE having a density in the range from ≥910 to ≤940 kg/m³, more preferably in the range from ≥920 to ≤930 kg/m³ as measured according to ISO 1183.

Preferably, the expandable bead comprises polyethylene, wherein the polyethylene is selected from LLDPE having a MFI in the range from ≥5 to ≤70 g/10 min, preferably from ≥6.0 to ≤60 g/10 min, more preferably from ≥8 to ≤55 g/10 min as measured according to ISO 1133 at 190° C. and 2.16 kg and having a density in the range from ≥910 to ≤940 kg/m³, more preferably in the range from ≥920 to ≤930 kg/m³ as measured according to ISO 1183.

Most preferably, the expandable bead comprises polyethylene, wherein the polyethylene is selected from LLDPE having a MFI in the range from ≥5 to ≤70 g/10 min, as measured according to ISO 1133 at 190° C. and 2.16 kg and having a density in the range from ≥910 to ≤940 kg/m³, as measured according to ISO 1183.

The expandable bead may comprise
a) a polyolefin mixture consisting of LLDPE and PP and
b) thermoplastic microspheres encapsulating a blowing agent.

The expandable bead may comprise
a) a polyolefin mixture consisting of LLDPE and PP and
b) thermoplastic microspheres encapsulating a blowing agent;
wherein the amount of LLDPE is in the range of ≥0.5 to ≤25% by weight, based on the total amount of polyolefin.

The expandable bead may comprise
a) a polyolefin mixture consisting of LLDPE and PP and
b) thermoplastic microspheres encapsulating a blowing agent;
wherein the amount of LLDPE is in the range of ≥0.5 to ≤25% by weight, based on the total amount of polyolefin and wherein the MFI of the LLDPE is in the range from ≥5 to ≤70 g/10 min, as measured according to ISO 1133 at 190° C. and 2.16 kg and the density of the LLDPE is in the range from ≥910 to ≤940 kg/m³, as measured according to ISO 1183.

Preferably the expandable bead comprises
a) a polyolefin mixture consisting of LLDPE and PP, and
b) thermoplastic microspheres encapsulating a blowing agent, wherein
the expandable bead comprises polypropylene in the range from ≥60% by weight to ≤98% by weight, more preferably from ≥80% by weight to ≤98% by weight, and LLDPE in the range from ≥2% by weight to ≤40% by weight, more preferably from ≥2% by weight to ≤25% by weight, based on the total amount of polyolefin.

Preferably, the expandable bead comprises the polyolefin mixture consisting of LLDPE and PP in the range from ≥70% by weight to ≤98% by weight,
preferably from >75% by weight to ≤98% by weight,
more preferably from ≥80% by weight to ≤98% by weight,
more preferably from ≥85% by weight to ≤98% by weight,
wherein the amount of the polyolefin mixture and the thermoplastic microspheres is 100% by weight.

Preferably, the expandable bead comprises
a) a polyolefin mixture consisting of LLDPE and random PP, and
b) thermoplastic microspheres encapsulating a blowing agent.

### High Density Polyethylene (HDPE)

The expandable bead may comprise HDPE. The MFI of the HDPE may be in the range from ≥0.1 to ≤100 g/10 min. Preferably, the MFI ranges from ≥0.6 to ≤80 g/10 min, more preferably from ≥5 and ≤80 g/10 min, more preferably from ≥10 to ≤70 g/10 min, more preferably from ≥10 to ≤60 g/10 min.

The MFI is measured according to ISO 1133-1:2011 at 190° C. and 2.16 kg.

The density of high density polyethylene may range from ≥940 and ≤960 kg/m³, more preferably from ≥945 to ≤955 kg/m³.

The density is measured according to measured according to ISO 1183-1:2012.

The HDPE may be unimodal HDPE or multimodal HDPE for example bimodal HDPE or trimodal HDPE. Preferably, the HDPE is bimodal HDPE.

The production processes of the HDPE and is summarised in “Handbook of Polyethylene” by Andrew Peacock (2000; Dekker; ISBN 0824795466) at pages 43-66. Suitable catalysts for the production of polyethylene include Ziegler Natta catalysts, chromium based catalysts and single site metallocene catalysts.

The unimodal polyethylene may be obtained for example by polymerizing ethylene and optionally at least one olefin comonomer in slurry in the presence of a silica-supported chromium-containing catalyst and/or an alkyl boron compound. Suitable comonomers include for example propylene, 1-butene, 1-pentene, 4-methyl-1-pentene, 1-hexene and/or 1-octene.

The unimodal polyethylene may be obtained for example by polymerizing ethylene and optionally at least one olefin comonomer in a gas phase polymerisation or in slurry polymerisation process.

The production processes for bimodal high density polyethylene (HDPE) are summarised at pages 16-20 of “PE 100 Pipe systems” (edited by Bromstrup; second edition, ISBN 3-8027-2728-2). The production of bimodal high density polyethylene (HDPE) via a low pressure slurry process is described by Alt et al. in “Bimodal polyethylene-Interplay of catalyst and process” (Macromol.Symp. 2001, 163, 135-143). The characteristics of the polyethylene are determined amongst others by the catalyst system and by the concentrations of catalyst, comonomer and hydrogen. The production of bimodal high density polyethylene (HDPE) via a low pressure slurry process may also be performed via a three stage process. The concept of the two stage cascade process is elucidated at pages 137-138 by Alt et al. “Bimodal polyethylene-Interplay of catalyst and process” (Macromol. Symp. 2001, 163).

The expandable bead may comprise
a) a polyolefin mixture consisting of HDPE and PP, and
b) thermoplastic microspheres encapsulating a blowing agent.

The expandable bead may comprise
a) a polyolefin mixture consisting of HDPE and PP, and
b) thermoplastic microspheres encapsulating a blowing agent;
wherein the amount of HDPE is in the range of ≥0.5 to ≤25% by weight, based on the total amount of polyolefin.

The expandable bead may comprise
a) a polyolefin mixture consisting of HDPE and PP, and
b) thermoplastic microspheres encapsulating a blowing agent;
wherein the amount of HDPE is in the range of ≥0.5 to ≤25% by weight, based on the total amount of polyolefin and wherein the MFI of the HDPE is in the range from ≥5 to ≤70 g/10 min, as measured according to ISO 1133 at 190° C. and 2.16 kg and the density of the HDPE is in the range from ≥940 to ≤960 kg/m³, as measured according to ISO 1183.

Preferably the expandable bead comprises
a) a polyolefin mixture consisting of HDPE and PP, and
b) thermoplastic microspheres encapsulating a blowing agent, wherein
the expandable bead comprises polypropylene in the range from ≥60% by weight to ≤98% by weight, more preferably from >80% by weight to ≤98% by weight, and HDPE in the range from >2% by weight to ≤40% by weight, more preferably from ≥2% by weight to ≤25% by weight, based on the total amount of polyolefin.

The expandable bead may comprise the polyolefin mixture consisting of HDPE and PP in the range from ≥70% by weight to ≤98% by weight,
preferably from >75% by weight to ≤98% by weight,
more preferably from ≥80% by weight to ≤98% by weight,
more preferably from >85% by weight to ≤98% by weight,
wherein the amount of the polyolefin mixture and the thermoplastic microspheres is 100% by weight.

The expandable bead may comprise
a) a polyolefin mixture consisting of HDPE and random PP, and
b) thermoplastic microspheres encapsulating a blowing agent.

### PP-UMS

PP-UMS refers to a polypropylene based, ultra melt strength resin, with a melt strength of at least 10 cN, preferably at least 20 cN, preferably at least 30 cN, preferably at least 40 cN, preferably at least 50 cN, preferably at least 60 cN, most preferably at least 65 cN.

Melt Strength is defined as the maximum (draw-down) force (in cN) by which a molten thread can be drawn before it breaks, e.g. during a Rheotens® measurement. Rheotens® measurements are done at a temperature of 200° C. A capillary of 20 mm length and 2 mm width is used. The starting velocity v0, is set to 9.8 mm/s. The acceleration is 6 mm/s².

The PP-UMS may have a melt flow rate (MFR) as measured according to ISO 1133-1:2011 at 230° C. and at a load of 2.16 kg in the range from 1.5 to 3.5 g/10 min, preferably in the range from 2.0 to 3.0 g/10 min, even more preferably in the range from 2.2 to 2.8 g/10 min.

DMS measurements are done with an ARES G2 rheometer at 200° C. measuring at frequencies of 0.01 rad/s to 100 rad/s, at a linear viscoelastic strain of 5%, using plates of 0.5 mm thickness produced according to ISO 1872-2:2007.

### a) Zero Shear Viscosity

The PP-UMS may have a zero shear viscosity as determined by DMS where viscosity data are fit using the Cross-model of ≥7000 Pas, more preferably ≥10000 Pas, more preferably ≥15000 Pas, more preferably ≥20000 Pas, even more preferably ≥23000 Pa·s.

### b) Viscosity Ratio (VR)

VR is the ratio of the complex viscosity n at given frequency divided by the complex viscosity at a frequency of 0.01 rad/s (η_{0.01}), wherein the complex viscosity is determined via DMS as described above.

The PP-UMS may have a viscosity ratio, VR100 defined as the ratio of complex viscosity at a frequency of 100 rad/s (η₁₀₀) divided by the complex viscosity at a frequency of 0.01 rad/s (η_{0.01}), of ≤0.03, more preferably ≤0.025.

The PP-UMS may have a viscosity ratio, VR10 defined as the ratio of complex viscosity at a frequency of 10 rad/s (η₁₀) divided by the complex viscosity at a frequency of 0.01 rad/s (η_{0.01}) of ≤0.08, more preferably ≤0.07.

The PP-UMS may have a viscosity ratio, VR1 defined as the ratio of complex viscosity at a frequency of 1 rad/s (η₁) divided by the complex viscosity at a frequency of 0.01 rad/s (η_{0.01}) of ≤0.22, more preferably ≤0.20.

The PP-UMS may have a viscosity ratio, VR0.1 defined as the ratio of complex viscosity at a frequency of 0.1 rad/s (η_{0.1}) divided by the complex viscosity at a frequency of 0.01 rad/s (η_{0.01}) of ≤0.50, more preferably ≤0.46.

PP-UMS grades are commercially available. One example is PP-UMS HEX17112 from SABIC.

### Thermoplastic Microspheres Encapsulating a Blowing Agent

The term thermoplastic microsphere is to be understood as a polymeric particle in which a blowing agent has been encapsulated.

Thermoplastic microspheres are known in the art and are for example described in detail in EP1981630A1, U.S. Pat. Nos. 3,615,972, 3,945,956, EP 486080, U.S. Pat. Nos. 5,536,756, 6,235,800, 6,235,394, 6,509,384, EP 1054034, EP 1288272 and EP1408097 and WO 2004/072160. Thermoplastic microspheres are commercially available for example from AkzoNobel under the tradename Expancel.

In such microspheres, the encapsulated blowing agent is usually a liquid having a boiling temperature not higher than the softening temperature of the thermoplastic polymer shell. Upon heating the blowing agent will vaporize, causing the internal pressure to increase, thereby expanding the microspheres, generally from about 2 to about 5 times their diameter. The expansion occurs when the temperature reaches above the glass transition temperature (Tg) of the polymeric microsphere shell, and when the internal pressure is high enough to overcome the modulus of the shell.

The microspheres may have a spherical shape. The microspheres may be impermeable to the blowing agent. The blowing agent may be present in an amount ranging from 5 to 95 percent by volume.

The diameter of the microsphere may be the range of from ≥0.5 μm to ≤0.5 centimeter prior to expansion. Preferably, the diameter ranges from ≥0.5 μm to ≤50 μm prior to expansion. More preferably, the diameter ranges from ≥0.5 to ≤40 μm prior to expansion. Even more preferably, the diameter ranges from ≥5 to about ≤40 μm prior to expansion.

The thermally expandable microspheres may be synthesized by suspension polymerization using radical polymerization. In general ethylenically unsaturated monomers are polymerized in the presence of a blowing agent. A wide variety of monomers may be employed to prepare microspheres comprising homo-or copolymers thereof.

Typical examples are alkenyl aromatic monomers such as styrene, methylstyrene and ethylstyrene, vinylbenzylchloride and other vinyl compouns such as vinyl acetate; vinyl propionate; vinyl butyrate; vinyl ether, vinylidene chloride; aryl butylether; aryl glycidyl ether; unsaturated carboxyl acids such as (meth) acrylic acid or maleic acid; alkyl (meth) acrylamides and the like, and combinations thereof. Other examples are acrylate based monomers, such as methyl methacrylate, methyl acrylate, ethyl acrylate, propyl acrylate, butyl acrylate, butyl methacrylate, propyl methacrylate, butyl methacrylate, lauryl acrylate, 2-ethylhexylacrylate, ethyl methacrylate, iso-butyl acrylate, t-butyl acrylate, n-octyl acrylate, stearyl acrylate, 2-hydroxyethyl acrylate, polyethylene glycol acrylate, methoxy polyethylene glycol acrylate, glycidyl acrylate, dimethyl amino-ethylacrylate, diethyl amino-ethyl acrylate, and the like, vinylidene chloride, butadiene.

Further examples of the polymerizable monomer may include unsaturated nitrile monomers such as acrylonitrile, methacrylonitrile, and the like; (meth) acrylic acid alkyl esters. A crosslinker may be added.

All the above mentioned monomers may be used independently, or two or more thereof may be used in combination.

The microsphere may comprise a wide variety of blowing agents. They can be volatile fluid-forming agents such as aliphatic hydrocarbons including ethane, ethylene, propane, propene, n-butane, isobutane, n-pentane, isopentane, neopentane, n-hexane, heptane, octane, isooctane (2,2,4-trimethylpentane) and petroleum ether; tetraalkylsilanes such as tetramethylsilane, trimethylethylsilane, trimethylisopropylsilane, and trimethyl-n-propylsilane, and mixtures thereof. Desirable among these are isobutane, petroleum ether, and mixtures thereof. These blowing agents may be used independently, or two or more thereof may be used in combination.

The invention also relates to the use of such thermoplastic microspheres for the manufacture of an expandable bead.

### Properties of the Expandable Beads

The expandable bead may have a spherical, rod-like, worm-like, irregular or any other shape. Preferably, the bead has a spherical shape.

For all shapes, the aspect ratio (D₁/D₂) of the bead may be in the range from ≥1.0 to ≤1.40, preferably from ≥1.0 to ≤1.30, preferably from ≥1.0 to ≤1.20, preferably from ≥1.0to ≤1.18.

D1 and D2 need to be understood as averaged diameters of the beads. From a representative sample of the beads, the smallest and largest diameter of at least 50 beads are measured and the resulting average values are D1 and D2. D₂ relates to the smallest diameter of the bead in case of non-spherical particles and D₁ to the largest diameter. The diameter can be measured by commonly known methods, such as for example described in ISO 13322-1 (2014) and ISO 13322-2 (2006). The aspect ratio needs to understood as ratio of the largest diameter D₁ of the beads to the smallest diameter D_{2.}

Preferably the expandable bead has a diameter D2 in the range from ≥0.5 to ≤2.5 mm, preferably the expandable bead has a diameter D2 in the range from ≥0.5 to ≤2.0 mm, preferably in the range from >0.8 to ≤2.0 mm, preferably in the range from ≥0.8 to ≤1.8 mm, preferably in the range from >0.8 to ≤1.5 mm, preferably in the range from ≥0.8 to ≤1.20 mm.

Diameter and aspect ratio of the bead are important for foaming properties and applications. Small diameter and aspect ratio ensures a compact filling of the mold, for example in steam chest molding, which leads to an article where the beads are densely packed and the bead foams' interfaces are effectively bonded. Excellent interbead bonding is important for the mechanical properties of the article, because the fracture usually forms and develops at the interbead bond.

A small diameter and aspect ratio of the bead are particularly important for thin walled articles, having a thickness of the cross-section of the article in the range from 5-20 mm, in order to obtain a smooth surface of the article.

More specifically the invention relates to an expandable bead comprising
a) a polyolefin selected from polyethylene (PE), polypropylene (PP) and mixtures thereof and
b) thermoplastic microspheres encapsulating a blowing agent,.

wherein the aspect ratio of the bead diameters, defined as quotient of the largest diameter D1 to the smallest diameter D2, is in the range from ≥1.0 to ≤1.40, more preferably from ≥1.0 to ≤1.20 and wherein the smallest diameter D2 of the bead is in the range from ≥0.5 to ≤2.5 mm.

Preferably the expandable bead comprises
a) a polyolefin selected from polyethylene (PE), polypropylene (PP) and mixtures thereof and
b) thermoplastic microspheres encapsulating a blowing agent,.
wherein the aspect ratio of the bead diameteres, defined as quotient of the largest diameter D1 to the smallest diameter D2, is in the range from ≥1.0 to ≤1.40 and wherein the smallest diameter D2 of the bead is in the range from ≥0.5 to ≤2.0 mm, preferably in the range from ≥0.8 to ≤2.0 mm, preferably in the range from ≥0.8 to ≤1.8 mm, preferably in the range from ≥0.8 to ≤1.5 mm, preferably in the range from ≥0.8 to ≤1.20 mm.

Preferably the expandable bead comprises
a) a polyolefin selected from polyethylene (PE), polypropylene (PP) and mixtures thereof and
b) thermoplastic microspheres encapsulating a blowing agent,.
wherein the aspect ratio of the bead diameters, defined as quotient of the largest diameter D1 to the smallest diameter D2, is in the range from ≥1.0 to ≤1.20 mm and wherein the smallest diameter D2 of the bead is in the range from ≥0.5 to ≤2.0 mm, preferably in the range from ≥0.8 to ≤2.0 mm, preferably in the range from ≥0.8 to ≤1.8 mm, preferably in the range from >0.8 to ≤1.5 mm, preferably in the range from ≥0.8 to ≤1.20 mm.

Preferably the expandable bead comprises
a) a polyolefin selected from polyethylene (PE), polypropylene (PP) and mixtures thereof and
b) thermoplastic microspheres encapsulating a blowing agent,.

wherein the aspect ratio of the bead diameteres, defined as quotient of the largest diameter D1 to the smallest diameter D2, is in the range from ≥1.0 to ≤1.40 and wherein the smallest diameter D2 of the bead is in the range from ≥0.5 to ≤2.5 mm and wherein the expandable bead comprises the polyolefin in the range from ≥70% by weight to ≤98% by weight,
preferably from >75% by weight to ≤98% by weight,
more preferably from ≥80% by weight to ≤98% by weight,
more preferably from >85% by weight to ≤98% by weight,
wherein the total amount of the polyolefin and the thermoplastic microspheres is 100% by weight.

More preferably the expandable bead comprises
a) a polyolefin selected from polyethylene (PE), polypropylene (PP) and mixtures thereof and
b) thermoplastic microspheres encapsulating a blowing agent,.
wherein the aspect ratio of the bead diameteres, defined as quotient of the largest diameter D1 to the smallest diameter D2, is in the range from ≥1.0 to ≤1.20 and wherein the smallest diameter D2 of the bead is in the range from >0.5 to ≤2.5 mm and wherein the expandable bead comprises the polyolefin in the range from >70% by weight to ≤98% by weight,
preferably from >75% by weight to ≤98% by weight,
more preferably from >80% by weight to ≤98% by weight,
more preferably from ≥85% by weight to ≤98% by weight,
wherein the total amount of the polyolefin and the thermoplastic microspheres is 100% by weight.

Also the standard deviation (StD) of the diameter D1 and/or D2 of the bead may be as small as possible as it ensures a homogenous and compact filling of the mold and leads to a smooth surface of the article. Preferably the standard deviation of the diameter D1and/or D2 is in the range from 0.08 to 0.50 mm, more preferably from 0.1 to 0.40 mm, even more preferably from 0.1 to 0.30 mm, even more preferably from 0.1 to 0.25 mm.

Further, the expandable bead may have a bulk density in the range from ≥430 to ≤600 kg/m³, preferably in the range from ≥440 to ≤600 kg/m³, preferably in the range from >440 to ≤560 kg/m³. Bulk density is measured according to ISO 60 (1977).

The advantage of the beads according to the invention is their shelf stability. This means that the bead can be expanded after a certain storage time period achieving the same bulk density compared to an expansion process directly after preparation of the beads provided that the same conditions for expanding the bead are used.

Hence, the beads are stable and do not lose their expansion capability over a certain time period. As a result, it is not necessary, for example, to store them in a container under pressure. Therefore, resulting expandable beads can be stored or transported as prepared. For example, when the beads are pre-foamed with steam after storage at atmospheric pressure, foamed beads with sufficient expansion and low density can be obtained.

The bead may have a shelf-stability of at least 6 month, preferably of at least 1.0 year, more preferably of at least 1.5 years, more preferably of at least 2.0 years.

The expandable bead may have a diameter in the range from ≥0.5 to ≤2.5 mm, preferably in the range from >0.8 to ≤2.0 mm and a bulk density in the range from ≥430 to ≤600 kg/m³, preferably in the range from ≥440 to ≤600 kg/m³, preferably in the range from ≥440 to ≤560 kg/m³ and a shelf-stability of at least 6 month, preferably of at least 1.0 year, more preferably of at least 1.5 years, more preferably of at least 2.0 years. Preferably, the expandable bead has a diameter in the range from ≥0.5 to ≤2.5 mm, and a bulk density in the range from ≥430 to ≤600 kg/m³ and a shelf-stability of at least 6 month.

When the bead is heated to a temperature sufficiently high to permit plastic flow and to vaporize or volatilize at least a portion of the blowing agent, the bead will expand. On cooling of the bead, the polyolefin will no longer flow and expand and it retains its increased dimension. This volume increase is retained upon cooling and might lead to a density reduction from about 600 kg/m³ to about 20 kg/m³. This unique expandable property reduces the density of the beads tremendously and makes them excellent for many applications.

The expandable bead may have a bulk density after its expansion in the range from ≥20 to ≤350 kg/m³, preferably in the range from ≥20 to ≤200 kg/m³, preferably in the range from ≥20 to ≤150 kg/m³, preferably in the range from ≥20 to ≤100 kg/m³. Bulk density is measured according to ISO 60 (1977).

The expansion ratio ER of the beads is defined as ratio of the bulk density before and after their expansion (ER =bulk density before expansion/bulk density after expansion). The expansion ratio ER of the beads is in range from ≥1.4 to ≤45, preferably from ≥2.0 to ≤45, preferably from ≥3.0 to ≤45, preferably from ≥5.0 to ≤45, preferably is in range from ≥5.0 to ≤15, more preferably from ≥5.0 to ≤12.

Preferably, the expandable bead has a diameter in the range from ≥0.5 to ≤2.5 mm, and a bulk density in the range from ≥430 to ≤600 kg/m³, a shelf-stability of at least 6 month and a bulk density after its expansion in the range from ≥20 to ≤350 kg/m³, preferably in the range from ≥20 to ≤200 kg/m³, preferably in the range from ≥20 to ≤150 kg/m³, preferably in the range from ≥20 to ≤100 kg/m³.

### Process for Producing Expandable Beads

The present invention also relates to a process for the production of the expandable beads.

The one or more polyolefin may be fed into an extruder at one or more input openings where it is melted and mixed. The one or more polyolefin may be fed to the extruder either as a blend, a dry-blend or as single components at different input openings. At a point on the extruder downstream from the input opening and before the exit opening, the thermoplastic microspheres may be fed to the extruder via an input opening. The input opening for adding the thermoplastic microspheres is preferably about ⅔ of the way from the input opening to the exit opening. The input opening may introduce the microspheres to the melt to form a mixture of the one or more polyolefin and the thermoplastic microspheres.

The process for mixing the components is not specifically restricted. Any mixing or kneading device may be used. Preferably the components are mixed in a single screw extruder, twin screw extruder or multi-screw extruder.

During the mixing step, one or more additive and/or one or more nucleating agent may be added. Preferably, the one or more additive and/or one or more nucleating agent are added after feeding the one or more polyolefin into the extruder at one or more input openings. One or more additives and/or one or more nucleating agent may be fed to be incorporated into the polyolefin mixture at one or more input opening. Preferably, the additives are fed to the extruder before the microspheres are fed to the extruder. The one or more additive and/or one or more nucleating agent may include the ones mentioned below. Each of these may be utilized to a greater or lesser degree depending on the required final properties desired in the foamed product.

After mixing, the molten mixture may be forced through an underwater pelletizing die into contact with moving water or any other suitable fluid, which cools the melt and inhibits expansion of the mixture. Water is the preferred fluid. The water may optionally be pressurized. Other suitable fluids may include fluids non-reacting and immiscible with the one or more polyolefins, e.g., nitrogen, helium, alcohols, polyols or glycols. As the mixture emerges from the die and is cooled by the liquid, preferably water, the mixture may be cut into beads by rotating cutting blades in a cutting chamber which contact the face of the die. The moving water may carry the pellets to a drying area where the beads may be removed from the water and dried.

The opening of the die, through which the mixture passes, defines the general shape of the resulting beads. The die opening may have any shape including rectangular, square, round, oval or even a non-symmetric shape to produce beads. The die can have multiple openings so that the expandable beads exits the die as beads.

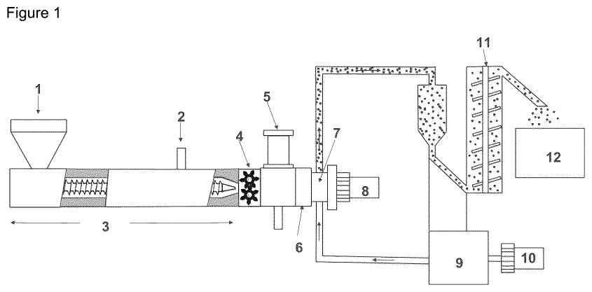

A typical set-up is shown in FIG. 1.

According to the present invention, the process for the production of expandable beads comprises the steps of:
(a) feeding one or more polyolefin, into melt mixing device; wherein the polyolefin is selected from polyethylene (PE), polypropylene (PP) and mixtures thereof;
(b) heating said one or more polyolefins to melt;
(c) introducing microspheres into said melt mixing device to form a mixture with the one or more polyolefin within the melt mixing device;
(d) supplying said mixture to a heated die comprising a plurality of holes grouped into pods on the face of said die;
(e) extruding said mixture through said holes into an underwater pelletizer which may optionally utilize a pressurized fluid system;
(f) cutting said mixture to form beads;
(g) removing said beads from the water; and
(h) drying said beads.

### Brief Description of FIG. 1

FIG. 1 is a scheme of the one-step extrusion setup for the process for the production of the expandable beads. The set-up includes the following elements
1-Inlet for Polymer
2-Inlet for thermoplastic microspheres containing blowing agent
3-Extruder
4-Melt Pump
5-Polymer Diverter
6-Die Plate
7-Cutting Chamber
8-Cutter Motor
9-Water Tank
10-Water Pump
11-Pellet Dryer
12-Collection Bin

### Additives

The polymers in the resin composition and also the resin composition according to the invention may contain additives, for instance nucleating agents and clarifiers, stabilizers, release agents, fillers, plasticizers, anti-oxidants, lubricants, antistatics, scratch resistance agents, thermal conductivity modifiers, high performance fillers, pigments and/or colorants, impact modifiers, blowing agents, acid scavengers, recycling additives, coupling agents, anti-microbial, anti-fogging additives, slip additives, anti-blocking additives, flame retardants, clays and polymer processing aids. These additives are well known in the art. The skilled person will choose the type and amount of additives such that they do not detrimentally influence the aimed properties of the composition.

### Nucleating Agent

Nucleating agents provide a multitude of nucleating sites each of which can induce formation of a cell during foam expansion. Nucleating agents give control over the cell morphology (namely, the number of cells, the cell size, and its distribution) in thermoplastic foams.

Examples of nucleating agents are talc, magnesium silicate, carbon black, graphite, titanium dioxide, calcium carbonate, calcium hydroxide, calcium stearate, zinc stearate, aluminum stearate, azodicarbonamide and sodium bicarbonate. Polymeric materials such as Nylons and PPO may also be used as the nucleating agent. All nucleating agents have particle sizes of approximately one micrometer or smaller.

Preferably, the expandable bead comprises a nucleating agent. A preferred nucleating agent is calcium carbonate.

### Expansion and Molding Process of the Expandable Bead

Expandable beads may be converted to the desired article in a two step process namely pre-expansion and molding. Each bead constitutes a foamable polymer composition comprising thermoplastic polymer matrix and thermoplastic microspheres encapsulating a blowing agent dispersed within the matrix.

Bead pre-expansion processes may be used for pre-expansion of the polymeric beads of this invention. Pre-expansion process can be summarized as transforming the beads, with the aid of a blowing agent into spheres of cellular structure possessing a larger volume and lower density.

Such pre-expansion processes comprise for example steam pre-expansion, infrared oven and hot air oven expansion.

Very common is the steam pre-expansion process, which can be a batch process or a continuous one. The steam pre-expansion processes are well known in the art. The skilled person will choose the process and the process conditions based on the downstream molding operations and intended applications of the foamed beads. It is essential to stir the expanding beads during pre-expansion to preclude beads agglomeration. Therefore, the pre-expansion vessel is normally fitted with a centrally located rotating stirrer and stationary breaker bars attached inside the vessel. Further it is required to use high pressure steam to reach a temperature to soften the beads, meaning raising the temperature close to the melting point of the polymer. The wet pre-expanded beads are discharged into a fluidized-bed where hot air dries the wet beads before they are transferred to silos for molding operations.

The steam chest molding process is commonly used for molding the pre-expanded beads into the desired articles. The steam chest molding processes for expandable polystyrene (EPS) and expanded PP beads are also well known in the art. In short, the beads are processed to articles by fusing the beads by the use of steam. The particles are fed into a mold, compressed and then perfused with steam. Thereby, the surface areas of the beads warm up and fuse with each other. The fused article is cooled down in the mold and then removed from it.

Unlike EPS, the existing commercially available expanded PP beads do not contain any blowing agent and have to be compensated by mechanical means during the molding process. The expandable beads of this invention may overcome this issue as these beads will contain residual blowing agent to assist the sintering of the beads by further expansion in the mold. The beads are also suitable to be molded by other fusion processes which are for example steam free.

The desired shapes of the article may be made by filling the closed cavity with the pre-expanded beads under pressure and heated to temperature above to softening point. As a result of this the further expansion of beads takes place filling up the free volume, fusing beads along the binding interfaces. After a cooling period (pressure reduction) the molded article is dimensionally stable and is released from the molding.

### Articles

Further the present invention relates to the use of such expandable beads for the production of expanded beads or an article, preferably molded articles, preferably for
i) automotive parts, preferably bumpers, steering column pads, sun visors, arm rests, head rests, seats, wheel house liner, side impact protectors and battery covers and/or
ii) packaging material, preferably dunnage trays, transport containers, medical and food containers requiring temperature control, sterility and damage protection during transport heat and sound management and/or
iii) furniture and safety and recreation applications.

The present invention may also relate to the use of such expandable beads for the production an article by steam chest molding. Preferably, the beads sinter by further expansion in the mold. Preferably, the beads do not need to be compensated during the molding process.

Further the invention relates to a process for making an article, preferably a molded article, preferably molded article made by fusion of the beads, more preferably a steam chest molded article, more preferably an automotive part and/or furniture and/or safety and recreation applications, by molding the expandable bead.

Further the invention relates to a process for making an article, preferably a molded article, preferably a molded article made by fusion of the beads, more preferably a steam chest molded article, more preferably an automotive part and/or furniture and/or safety and recreation applications, by molding the expandable bead, wherein the expandable bead comprises
a) a polyolefin selected from polyethylene (PE), polypropylene (PP) and mixtures thereof and
b) thermoplastic microspheres encapsulating a blowing agent

Preferably, in the process, bumpers, steering column pads, sun visors, arm rests, head rests, seats, wheel house liner, side impact protectors and battery covers and/or a packaging material, preferably dunnage trays, transport containers, medical and food containers requiring temperature control, sterility and damage protection during transport heat and sound management are produced.

Further the invention relates to a process for making an article by for examples steam chest molding, wherein the desired shapes of the article are preferably made by filling the closed cavity with the pre-expanded beads under pressure and heating to a temperature above to softening point, whereby the beads are fused along the binding interfaces.

Furthermore, the present invention relates to an article, preferably a molded article, more preferably a molded article made by fusion of the beads, more preferably a steam chest molded article comprising the expandable beads according to the invention or obtainable by a process according the invention.

The invention deals also with an article, preferably a molded article, preferably a steam chest molded article made from the expandable bead according to the invention or made from the expandable bead obtained by or obtainable by the process according to the invention.

The invention deals also with an article, preferably a molded article, preferably a molded article made by fusion of the beads, preferably a steam chest molded article made from an expandable bead, wherein the expandable bead comprises
a) a polyolefin selected from polyethylene (PE), polypropylene (PP) and mixtures thereof and
b) thermoplastic microspheres encapsulating a blowing agent

Preferably the articles are parts for automotive applications, such as bumpers, steering column pads, sun visors, arm rests, head rests, seats, wheel house liner, side impact protectors and battery covers and/or packaging material, such as dunnage trays, transport containers, medical and food containers requiring temperature control, sterility and damage protection during transport heat and sound management, made from the expandable bead according to the invention or made from the expandable bead obtained by or obtainable by the process according to the invention.

The foamed beads and foamed article made from the expandable polymer beads of the invention may have a density in the range from 10 to 400 kilograms per cubic meter (kg/m³), preferably 100 kg/m³ or less, still more preferably 50 kg/m³ or less. Typically, the foamed beads and the foamed article made from the expandable polymer beads of the present invention have a density of 10 kg/m³ or higher, preferably 20 kg/m³ or higher, preferably 30 kg/m³ or higher in order to ensure mechanical integrity during handling. Most preferably, the density is in range from 30 to 50 kg/m³. Lower density foamed beads and foamed articles are desirable to reduce cost of manufacture and transportation as well as for ease of handling. The foam density is determined according to the method of ISO 845-95.

The open cell content of the foamed bead or the foamed article made from the expandable bead of the present invention may be 30% or less, preferably 10% or less, more preferably 5% or less, even more preferably 2% or less. The open cell content may be 1% or less or even 0%. The open cell content is determined according the method of ASTM D6226-05.

The invention will now be illustrated by the following non-limiting examples.

### EXAMPLES

### Materials

The materials mentioned in Table 1 were used.

TABLE 1
Used Materials.

| | | MFI in | |
|---|---|---|---|
| | | g/10 min | Density in kg/m³ |
| | | Measurement | Measurement |
| Material | Grade name | method | method |
| PP | SABIC, | 8.0 | 905 |
| | PP 621P | ISO 1133-1:2011 | ISO 1183-1:2012 |
| | | 2.16 kg at 230° C. | |
| PP | SABIC, | 45 | 905 |
| | QR6711K | ASTM D1238 | ASTM D792 |
| | | 2.16 kg at 230° C. | |
| LLDPE | SABIC, | 50 | 926 |
| | M500026 | ASTM D1238 | ASTM D1505 |
| | | 2.16 kg at 190° C. | |
| Microspheres | Akzo Nobel | | |
| | Expancel | | |
| | 980 DU 120 | | |

### Measurement Methods

The bead diameter is directly measured from the micrographs according to ISO 13322-1 (2014). The beads are attached to a standard slide and viewed by Olympus 510 digital light microscope. The images of at least 50 beads are recorded in reflected light mode.

Both D1 and D2 diameters of the beads are measured using an image analysis software Image J.

The bulk density of the raw beads is measured using a one or two liter cylinder and collecting the beads into the cylinder to full capacity. Leveling the surface to the cylinder and taking the weight of the beads.

The bulk density of the expanded beads is also measured using a one or two liter cylinder and collecting the expanded beads into the cylinder to full capacity. Leveling the surface to the cylinder and taking the weight of expanded beads (these beads should be free from agglomerates or lumps).

### Preparation of Beads

The expandable beads were prepared using a twin screw extruder from Berstorff and an underwater pelletizing system from Nordson BKG. The conditions of Table 2 were applied.

TABLE 2
Process parameters.

| Parameter | | Value |
|---|---|---|
| Die Plate | Number of holes | 152 |
| | Hole Diameter (mm) | 0.65 |
| Cutter Hub | Number of Blades | 12-22 |
| | Inclination | Angle-Straight |

| | |
|---|---|
| Feed Throughput (kg/hr) | 190-250 |
| Temperature of Die Plate (° C.) | 145-260 |
| Melt Pressure Die Plate (bar) | 135-225 |
| Melt Temperature (° C.) | 169-212 |
| Process water Temperature (° C.) | 31-45 |
| Water Flow (m³/hr) | 15-31 |
| Extruder Speed (rpm) | 100-120 |
| Pelletizer Speed (rpm) | 3500-3800 |

### Expansion of the beads

The expansion data reported in the Tables below are generated using a hot air oven. The oven was preheated to 180° C. and a known quantity of the beads was placed in the oven in an open aluminum pan. After the prescribed time the sample was withdrawn from the oven and bulk density of the beads was measured using a container of fixed volume.

TABLE 3a
Preparation of beads with different ratios of PP QR6711K and Expancel.
For expansion of the beads a temperature of 180° C. was used.

| | | | | | | | Bulk |
|---|---|---|---|---|---|---|---|
| | | | | | Bead | Bead | Density of |
| | | | | Water | Diameter | Bulk | Expanded |
| | Bead Composition (wt %) | | | Pressure of | range | Density | Beads |
| | PP6711 | Expancel | CaCO₃ | UWP (bar) | (mm) | (kg/m³) | (kg/m³) |
| 1 | 100 | 0 | 0 | 2 | 1.1-1.4 | 560 | N/A |
| 2 | 100 | 0 | 0 | 10 | 1.1-1.5 | 560 | N/A |
| 3 | 97.5 | 2.5 | 0 | 2 | 1.0-1.3 | 531 | 325 |
| 4 | 95 | 5 | 0 | 3.8 | 0.9-1.5 | 490 | 160 |
| 5 | 92.5 | 7.5 | 0 | 3.8 | 1.1-1.5 | 475 | 93 |
| 6 | 90 | 10 | 0 | 3.8 | 1.2-1.7 | 440 | 80 |
| 7 | 89.55 | 10 | 0.45 | 3.8 | 1.1-1.4 | 450 | 82 |
| 8 | 80 | 20 | 0 | 10 | 1.2-1.7 | 535 | 57 |

UWP: Under Water Pelletizer

TABLE 3b
Preparation of beads with differen
ratios of PP QR6711K and Expancel.

| | | | | | StD. | | StD. | |
|---|---|---|---|---|---|---|---|---|
| | Bead Composition (wt %) | | | D1 | D1 | D2 | D2 | Aspect |
| | PP6711 | Expancel | CaCO₃ | (mm) | (mm) | (mm) | (mm) | ratio |
| 1 | 100 | 0 | 0 | 1.25 | 0.15 | 1.11 | 0.13 | 1.12 |
| 2 | 100 | 0 | 0 | 1.24 | 0.11 | 1.09 | 0.13 | 1.14 |
| 3 | 97.5 | 2.5 | 0 | 1.31 | 0.16 | 1.15 | 0.16 | 1.14 |
| 4 | 95 | 5 | 0 | 1.34 | 0.24 | 1.14 | 0.19 | 1.17 |
| 5 | 92.5 | 7.5 | 0 | 1.33 | 0.16 | 1.13 | 0.18 | 1.18 |
| 6 | 90 | 10 | 0 | 1.39 | 0.21 | 1.19 | 0.16 | 1.16 |
| 7 | 89.55 | 10 | 0.45 | 1.29 | 0.18 | 1.13 | 0.15 | 1.15 |
| 8 | 80 | 20 | 0 | 1.25 | 0.15 | 1.11 | 0.13 | 1.12 |

D-diameter, STD-standard deviation, aspect ratio = D1/D2

TABLE 4
Preparation of beads with PP QR6711K and Expancel. The beads
were expanded with different expansion times. For expansion
of the beads a temperature of 180° C. was used.

| | | | | | | | Bulk |
|---|---|---|---|---|---|---|---|
| | | | | Bead | | | Density of |
| | | | | Bulk | Bead Dia. | Expansion | Expanded |
| | Bead Composition (wt %) | | | Density | Range | Time | Beads |
| | PP | Expancel | CaCO₃ | (kg/m³) | (mm) | (min) | (kg/m³) |
| 8a | 80 | 20 | 0 | 535 | 1.2-1.7 | 5 | 100 |
| 8 | 80 | 20 | 0 | 535 | 1.2-1.7 | 10 | 57 |
| 8b | 80 | 20 | 0 | 535 | 1.2-1.7 | 15 | 50 |

Under Water Pelletizer 10 bar.

TABLE 5
Preparation of beads with PP QR6711K,
LLDPE M500026 and Expancel.

| | | | | | | Bulk |
|---|---|---|---|---|---|---|
| | Bead Composition (wt %) | | | Bead | | Density of |
| | 80/20 | | | Bulk | Bead Dia. | Expanded |
| | PP/PE | | | Density | Range | Beads |
| | Blend | Expancel | CaCO₃ | (kg/m³) | (mm) | (kg/m³) |
| 1 | 100 | 0 | 0 | 549 | 1.0-1.6 | N/A |
| 2 | 90 | 10 | 0 | 545 | 1.1-1.6 | 175 |
| 3 | 80 | 20 | 0 | 509 | 1.1-1.6 | 62 |

Expansion Temperature 180° C., Water Pressure of Under Water Pelletizer 10 bar.

TABLE 6a
Preparation of beads with PP 621P and Expancel.

| | | | | | | | Bulk |
|---|---|---|---|---|---|---|---|
| | | | | Water | Bead | | Density of |
| | | | | Pressure | Diameter | Bead Bulk | Expanded |
| | Bead Composition (wt %) | | | in UWP | range | Density | Beads |
| | PP621 | Expancel | CaCO₃ | (bar) | (mm) | (kg/m³) | (kg/m³) |
| 1 | 100 | 0 | 0 | 2 | 1.0-1.3 | 550 | N/A |
| 2 | 97.5 | 2.5 | 0 | 3.8 | 1.1-1.5 | 500 | 350 |
| 3 | 95 | 5 | 0 | 3.8 | 1.2-1.4 | 470 | 187 |
| 4 | 90 | 10 | 0 | 3.8 | 1.2-1.6 | 450 | 120 |

Expansion temperature 180° C.

TABLE 6b
Preparation of beads with PP 621P and Expancel.

| | | | | | StD. | | StD. | |
|---|---|---|---|---|---|---|---|---|
| | Bead Composition (wt %) | | | D1 | D1 | D2 | D2 | Aspect |
| | PP621 | Expancel | CaCO₃ | (mm) | (mm) | (mm) | (mm) | ratio |
| 1 | 100 | 0 | 0 | 1.33 | 0.16 | 1.13 | 0.15 | 1.17 |
| 2 | 97.5 | 2.5 | 0 | 1.35 | 0.16 | 1.14 | 0.13 | 1.18 |
| 3 | 95 | 5 | 0 | 1.37 | 0.14 | 1.18 | 0.12 | 1.16 |
| 4 | 90 | 10 | 0 | 1.27 | 0.08 | 1.08 | 0.11 | 1.18 |

D - diameter, STD - standard deviation, aspect ratio = D1/D2

The bead shelf life was demonstrated by pre-expanding (or molding) of the beads after storing the product at room temperature for different intervals of time. The pre-expansion (or molding) experiments were conducted at identical conditions to those used with the fresh beads. These results are shown in Table 7.

TABLE 7
Expansion of beads with PP QR6711K and Expancel.

| | | | | | | Bulk Density of Expanded Beads (kg/m³) | | | |
|---|---|---|---|---|---|---|---|---|---|
| | | | | Bulk | | Expansion after different time intervals | | | |
| | | | | Density | Expansion/ | directly after | | | |
| | Bead Composition (wt %) | | | of Bead | Molding | preparation of | 1 | 4 | 6 |
| | PP | Expancel | CaCO₃ | (kg/m³) | Temp. | the beads | month | month | month |
| 1 | 95 | 5 | 0 | 490 | 180° C. | 160 | 160 | 160 | 160 |
| 2 | 89.55 | 10 | 0.45 | 450 | 180° C. | 82 | 80 | 80 | 80 |
| 3 | 90⁽¹⁾ | 10 | 0 | 545 | 180° C. | 175 | 175 | 175 | |
| 4 | 80 | 20 | 0 | 535 | 180° C. | 75⁽²⁾ | 75⁽²⁾ | 75⁽²⁾ | |

⁽¹⁾90% of a 80/20 PP/PE blend of PP QR6711K and LLDPE M500026 instead of pure PP, ⁽²⁾Plaque density.
(sample 1 = sample 4 of table 3, sample 2 = sample 10 of table 3, sample 3 = sample 2 of table 5, sample 4 = sample 8 of table 3.)

The results presented above clearly demonstrate the feasibility of the process of making expandable beads using a composition of PP and microspheres or a composition of blends of PP and other polyolefins and microspheres.

The results of Table 7 show that the beads are shelf stable. Shelf-stable in this context means that the beads can be stored for a certain period of time without losing their properties. In particular this means that the beads can be foamed to the extend and with the same result as they would have been foamed directly after their production provided that the same process conditions are used.

It was possible to achieve the same low bulk densities by expansion directly after their preparation and after storage of the unexpanded beads for at least 6 month. This means that the beads can be stored and transported in an unexpanded state before they are expanded. This is a huge advantage and saves transportation costs.

1. A process for making an article comprising providing a plurality of expandable beads which comprises a polyolefin selected from polyethylene, polypropylene, and mixtures thereof and thermoplastic microspheres encapsulating a blowing agent, and molding the expandable beads.

2. The process of claim 1 wherein an aspect ratio, defined as quotient of a largest diameter D1 of the bead to a smallest diameter D2 of the bead, is in the range from ≥1.0 to ≤1.40, wherein the smallest diameter D2 of the bead is in the range from ≥0.5 to ≤2.5 mm.

3. The process of claim 1 wherein the expandable bead comprises the polyolefin in the range from >70% by weight to ≤98% by weight, wherein the total amount of the polyolefin and the thermoplastic microspheres is 100% by weight.

4. The process of claim 1 wherein the expandable bead comprises a polypropylene having a melt flow index (MFI) of from ≥5 to ≤60 g/10 min, as measured according to ISO 1133 at 230° C. and a load of 2.16 kg.

5. The process of claim 1 wherein the expandable bead comprises a polypropylene homopolymer or a random polypropylene copolymer, a linear low density polyethylene having a melt flow index in the range from ≥5 to ≤70 g/10 min as measured according to ISO 1133 at 190° C. and 2.16 kg and/or having a density in the range from ≥910 to ≤940 kg/m³ as measured according to ISO 1183; and/or a high density polyethylene having a MFI in the range from ≥5 to ≤70 g/10 min as measured according to ISO 1133 at 190° C. and a load of 2.16 kg and/or having a density in the range from ≥940 to ≤970 kg/m³ as measured according to ISO 1183.

6. The process of claim 1 wherein the expandable bead has a bulk density in the range from ≥430 to ≤600 kg/m³.

7. The process of claim 1 wherein the expandable bead has a shelf-stability of at least 6 month and has been stored for at least 6 months before molding.

8. The process of claim 1 wherein the expandable bead is characterized by a bulk density after its expansion in the range from ≥20 to ≤350 kg/m³.

9. The process of claim 1 wherein the thermoplastic microspheres have a size in the range from ≥0.5 μm to ≤50 μm.

10. The process of claim 1 wherein the expandable beads are pre-expanded before being fed into a mold where the beads are fused to each other.

11. The process of claim 10 wherein expanded beads are compressed and perfused with steam to fuse with each other.

12. The process of claim 10 wherein further expansion occurs by heating in the mold to a temperature above a softening point.

13. The process of claim 1 wherein the expandable beads expand during heating in the mold.

14. An article made by the process of claim 1.

15. The article of claim 14 which is an automotive part, packaging material, or furniture.

16. The article of claim 15 which is an automotive part selected from bumpers, steering column pads, sun visors, arm rests, head rests, seats, wheel house liner, side impact protectors and battery covers.

17. The article of claim 14 which is a packaging material selected from dunnage trays, transport containers, medical and food containers requiring temperature control, sterility and damage protection during transport heat and sound management.

18. A process for the production of an expandable bead comprising the steps of:
(a) feeding one or more polyolefins, into melt mixing device; wherein the polyolefin is selected from polyethylene (PE), polypropylene (PP) and mixtures thereof;
(b) heating said one or more polyolefins to melt;
(c) introducing microspheres into said melt mixing device to form a mixture with the one or more polyolefins within the melt mixing device;
(d) supplying said mixture to a heated die comprising a plurality of holes grouped into pods on the face of said die;
(e) extruding said mixture through said holes into an underwater pelletizer which may optionally utilize a pressurized fluid system;
(f) cutting said mixture to form beads;
(g) removing said beads from the water; and
(h) drying said beads,
wherein an aspect ratio, defined as quotient of a largest diameter D1 of the bead to a smallest diameter D2 of the bead, is in the range from ≥1.0 to ≤1.40, wherein the smallest diameter D2 of the bead is in the range from ≥0.5 to ≤2.5 mm.
